(19) United States
(12) Patent Application Publication
(10) Pub. No.: US 2010/0074111 A1
(43) Pub. Date: Mar. 25, 2010

(54) METHOD OF DATA TRAFFIC SHAPING, APPARATUS AND WIRELESS DEVICE

(76) Inventors: Vijayanand KRISHNAPRASAD, Munchen (DE); Dan DINESCU, Munich (DE)

Correspondence Address: INFINEON TECHNOLOGIES AG;Patent Department, MUC 11.1.507, P.O. Box 221644, Munich, 80506, DE

(21) Appl. No.: 12/234,770

(22) Filed: Sep. 22, 2008

(51) Int. Cl. G08C 15/00; H04L 12/26; H04J 3/16

(52) U.S. Cl. 370/231; 370/230.1; 370/241; 370/465

(57) ABSTRACT

A method of data traffic shaping, an apparatus and a wireless device are provided. The method of data traffic shaping comprises controlling a transmission rate of acknowledgements, the acknowledgements being transmitted in a high speed direction of a data connection and the acknowledgements acknowledging receipt of data being transmitted in a low speed direction of the data connection. An apparatus is configured to carry out the method. A wireless device may include the apparatus.

### TECHNICAL FIELD

Embodiments of the invention relate generally to a method of data traffic shaping, to an apparatus and to a wireless device.

### BRIEF DESCRIPTION OF THE SEVERAL VIEWS OF THE DRAWINGS

FIG. 1 shows a method of data traffic shaping in accordance with an embodiment of the invention.

FIG. 2 shows a block diagram of an apparatus in accordance with an embodiment of the invention.

### DETAILED DESCRIPTION OF THE INVENTION

The following detailed description explains exemplary embodiments of the present invention. The description is not to be taken in a limiting sense, but is made only for the purpose of illustrating the general principles of the invention. The scope of the invention, however, is only defined by the claims and is not intended to be limited by the exemplary embodiments described below. Where applicable the description of a method embodiment is deemed to describe also the functioning of a corresponding device embodiment and vice versa.

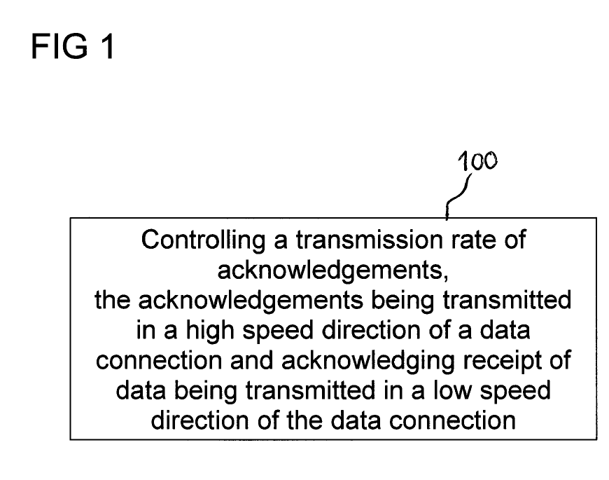

In FIG. 1 a method of data traffic shaping in accordance with an embodiment of the invention is shown.

Data traffic shaping usually means that the data flow over a data connection (the “traffic”) is purposely affected. Thus a behaviour of the data connection or the data flow itself may be improved.

At 100, a transmission rate of acknowledgements is controlled, the acknowledgements being transmitted in a high speed direction of a data connection and acknowledging receipt of data being transmitted in a low speed direction of the data connection.

A data connection used to transmit data may be used to transmit data in opposite directions simultaneously. The data may be transmitted over separate transmission channels in each direction or may be transmitted using a single transmission channel in a time-multiplexed fashion. In any such case it is generally desirable that a data transfer in one direction does not disturb a simultaneous data transfer in the other direction.

A bidirectional data connection can have a high speed direction and a low speed direction. One can also say that it may have a high speed path and a low speed path. Such a data connection is called an asymmetrical data connection. For example, ADSL (Asymmetrical Digital Subscriber Line), which is a wireline data connection, and HSDPA (High Speed Downlink Packet Access), which is a wireless data connection, are strongly asymmetrical data connections. An asymmetrical data connection usually provides a high transmission speed in downlink (which is usually the direction from a network or a server to a terminal or a user) and usually provides a low transmission speed in uplink (which is usually the direction from a terminal or a user to a network or a server).

On an asymmetrical data connection a data transfer in the high speed direction (e.g. downlink) may be severely affected by any data transfers in the low speed direction (e.g. uplink). This is especially the case when the data connection is operated according to the Transmission Control Protocol TCP.

A data transmission in the low speed direction may easily overload the available transmission capacity. On a strongly asymmetrical data connection the transmission capacity of the low speed direction is much lower than that of the high speed direction. To say it in other words, a saturation of the transmission bandwidth in the low speed direction may occur.

At the same time data are transmitted in the high speed direction of the data connection at a high data rate which is made possible by the high transmission capacity of the high speed direction. Acknowledgements acknowledging receipt of these high speed data are generated upon receiving the data. The acknowledgements are to be transmitted back to the sender of the high speed data using the low speed direction.

As a consequence of a saturation of the transmission bandwidth in the low speed direction, the acknowledgements acknowledging receipt of data being transmitted in the high speed direction of the data connection cannot be properly transmitted. For instance they get stuck in a long waiting queue of all the other data to be transmitted in the low speed direction. The sender of the high speed data does not receive acknowledgements for the high speed data timely enough and slows down or even interrupts the data transfer in the high speed direction.

As can be seen from what was said above a saturation of the transmission bandwidth in the low speed direction may lead to slowing down a high speed data transfer in the other direction, thus leaving a large portion of the transmission bandwidth available in the high speed direction unused.

In order to better utilize the bandwidth in the high speed direction a method of traffic shaping may be used.

In the following the traffic shaping is explained further. An embodiment of the invention is considered where a client computer is connected with a server computer via an asymmetrical data connection according to the Transmission Control Protocol (TCP). The asymmetrical data connection provides a high transmission speed in downlink (DL), which is from the server to the client, and it provides a low transmission speed in uplink (UL), which is from the client to the server.

A computer program that runs on the client computer or on a router associated with the data connection may be used as a traffic shaper. The traffic shaper may monitor the applications on the client computer and limit the data they are allowed to send in the UL, thus avoiding to saturate the bandwidth (BW) available in UL. The TCP acknowledgements (ACKs) can then be transmitted in UL immediately. The traffic shaper may filter the ACKs for the DL data packets and give them a higher priority against the other UL data packets. Thus the ACKs don't have to wait in the queues and can be transmitted in UL immediately, even if the BW in UL is saturated.

The approaches described in the preceding paragraph may work well but are not appropriate in all cases. Such a case is when the client computer is connected to the network (the server computer) using a mobile phone or a wireless modem or the like, generally referred to as a wireless device in the following.

Even if the TCP ACKs would receive a higher priority and thus would not have to wait in the queues of the wireless device, the gain is little because these queues are rather small when compared to the buffers in the client computer which may be a Personal Computer (PC) or the like. The data buffers in the wireless device can be quickly filled up only with data an application on the client computer wants to send in UL. So no ACK is present in the data buffer (the queue) of the wireless device to be filtered out and to be put in front of the other data. An attempt to give the TCP ACKs a higher priority with respect to the queues of the wireless device might therefore not work well.

Controlling the portion of the BW in UL which is allowed to be used by applications on the client computer would mean the user has to install special software which means additional costs and potentially configuration work.

In accordance with embodiments of the invention the ACKs for the UL data packets, which ACKs are transmitted in DL, are manipulated. The target of this manipulation is to limit the used BW in UL to a value which gives also the ACKs for the DL data packets the needed portion of BW. Thus the UL BW will not get saturated and the UL queues across the system will not fill up. This will minimize the delays imposed to the ACKs for the DL data packets.

In accordance with embodiments of the invention the traffic shaping is based on controlling the ACKs for the UL data packets. Thus the portion of the BW in UL used by the UL data packets is limited and saturation of the BW in UL may be avoided.

Embodiments of the invention have the following advantages: Manipulating the ACKs for the UL data packets can be fully and transparently implemented in the wireless device or router or the like. The client computer and the server computer and the rest of the data connection (data path) need not to be changed. The additional memory needed for handling and intermediate storing of the ACKs for the UL data packets is very small as the ACK packets are usually only approximately a few tens of bytes each.

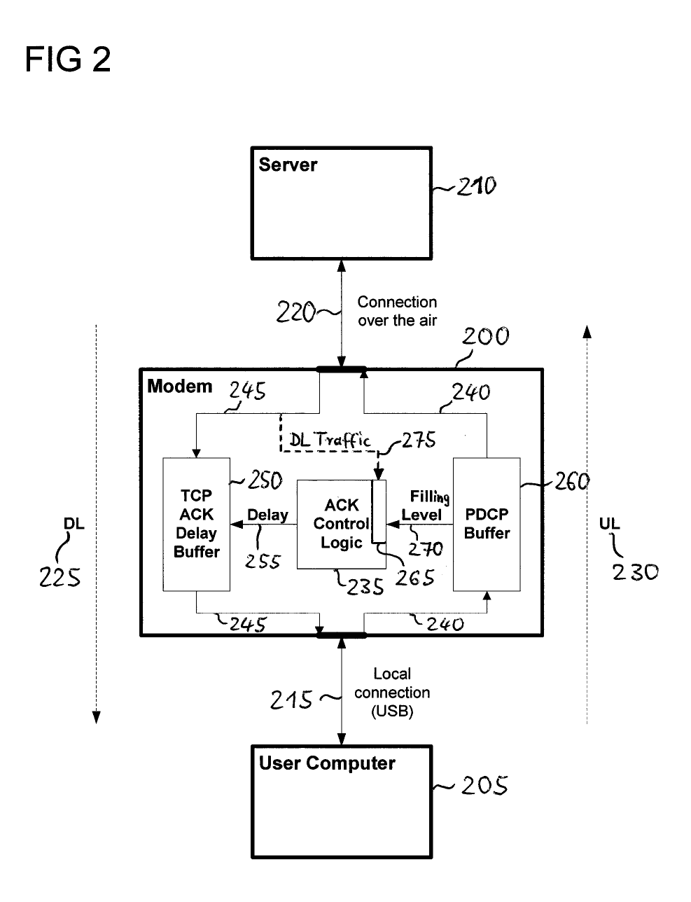

In FIG. 2 a block diagram of an apparatus in accordance with an embodiment of the invention is shown. The apparatus is included in a wireless device 200, which for example is a dedicated wireless modem for data transfer or a wireless modem integrated in a mobile phone or PDA (personal digital assistant).

A client computer (user computer) 205, which for example is a Personal Computer (PC), is connected with a server computer 210 via an asymmetrical data connection 215, 220 according to the Transmission Control Protocol (TCP). The asymmetrical data connection includes a local connection 215, e.g. a USB (Universal Serial Bus) connection, between the client/user 205 and the wireless device 200, and includes a connection over the air 220 between the wireless device 200 and the server 210. It provides a high transmission speed in downlink (DL) 225, which is the direction from the server 210 to the client 205, and it provides a low transmission speed in uplink (UL) 230, which is the direction from the client 205 to the server 210.

The wireless device 200 includes a control unit (“ACK control logic”) 235 to manipulate ACKs for the UL data packets. These ACKs are transmitted in the DL. The UL path in the wireless device 200 is shown as data lines 240 and the DL path in the wireless device 200 is shown as data lines 245.

The manipulation of the ACKs for UL data packets, which are received in DL from the server 210, is done by controlling, and limiting if needed, the rate of the ACKs which are forwarded to the client 205. The received ACKs which are not forwarded immediately, that is to say which are delayed, are stored for some time in a delay buffer 250. A control parameter “Delay” 255 determining the delay time is set by the control unit 235 and used at the delay buffer 250. The control parameter “Delay” 255 is varied as needed.

Furthermore the “window size” field in the ACKs which are forwarded to the client 205 is set to a low or even very low value (accommodating only few TCP segments), thus limiting the number of data packets which are allowed to be sent in the UL direction without acknowledgement. The parameter “window size” indicates in the ACK how much data the receiver can still accept. It is usually used to make sure that the sender will not overflow the receiver's buffers. The window size parameter may have to be changed from a given high value (indicating large available receiver buffer size) to the low value. According to an embodiment, the value of the window size parameter is generally limited to a low value. This will make sure that only a limited number of data packets are ‘on the fly’. Thus the stream of UL data packets will react faster to a delay of an ACK.

With these control measures, the utilisation of the BW in UL will be determined by the “ACK max transfer rate” (ACK packets/sec), the “TCPAckFrequency” (number of TCP segments acknowledged with one ACK) and the “Size of the TCP segment”. The utilised BW in UL should be ideally very close to the respective maximum available taking into account the respective operating conditions and configurations, but not exceed the maximum, that is to say a saturation of the available BW in UL should be avoided.

This can be achieved by checking the filling levels in any of the modem buffers used to buffer data in UL and by controlling the transmission rate in DL of ACKs for the UL data accordingly. At a HSDPA modem a convenient way is to check the PDCP (Packet Data Convergence Protocol) buffer filling level. The PDCP buffer 260 is arranged in the UL path 240. Its filling level is monitored by the monitoring unit 265. The monitoring unit 265 may be a separate unit or may be integrated in the control unit 235. A control parameter “Filling Level” 270 is provided to be used at the control unit 235. As an alternative or in addition the activation rate of the UL data flow control (indicating the frequency the buffers get filled above a certain threshold) can be monitored to provide information about the utilisation of the available BW in UL.

The starting ACK transmission rate should be the one given by an UL transfer only. By monitoring the levels in the PDCP buffer 260 (or how often the UL flow control is activated) the control unit 235 receives input to control the ACK transmission rate accordingly. The rate can be decreased or increased again as needed. This will make sure that, in average, the PDCP buffer 260 is not full, i.e. the UL is not saturated. In order to prevent the PDCP buffer 260 from becoming empty, ACKs can be sent immediately without any delay. This will lead to additional data packets to be sent in UL.

Another way to optimize the data traffic on the data connection 215, 220 is to monitor the used BW in DL, that is to say to monitor the DL traffic, and to modulate the ACK transfer rate in DL (of ACKs for UL data packets) in order to find the maximum in the used BW in DL. The monitoring unit 265 may be configured to monitor the used BW in DL. A control parameter “DL Traffic” 275 may be provided to be used at the control unit 235, as an alternative to or in addition to the control parameter “Filling Level” 270.

1. Method of data traffic shaping, comprising:
controlling a transmission rate of acknowledgements, the acknowledgements being transmitted in a high speed direction of a data connection and the acknowledgements acknowledging receipt of data being transmitted in a low speed direction of the data connection.

2. The method as recited in claim 1, wherein the controlling depends on a degree of utilisation of a transmission bandwidth in the low speed direction of the data connection.

3. The method as recited in claim 1, wherein the controlling includes avoiding a saturation of a transmission bandwidth in the low speed direction of the data connection.

4. The method as recited in claim 1, wherein the controlling includes limiting the transmission rate of acknowledgements.

5. The method as recited in claim 1, wherein the controlling includes delaying the acknowledgements.

6. The method as recited in claim 1, wherein the controlling includes limiting a value of a window size parameter in the acknowledgements.

7. The method as recited in claim 1, further comprising:
monitoring a filling level of a data buffer in the low speed direction of the data connection.

8. The method as recited in claim 1, further comprising:
monitoring an activation rate of a data flow control in the low speed direction of the data connection.

9. The method as recited in claim 1, wherein the controlling includes avoiding a complete filling of a data buffer in the low speed direction of the data connection.

10. The method as recited in claim 1, further comprising:
monitoring a degree of utilisation of a transmission bandwidth in the high speed direction of the data connection.

11. The method as recited in claim 1, wherein the controlling includes maximising a degree of utilisation of a transmission bandwidth in the high speed direction of the data connection.

12. The method as recited in claim 1, wherein the controlling includes maximising a transmission rate of further acknowledgements, the further acknowledgements being transmitted in the low speed direction of the data connection and acknowledging receipt of further data being transmitted in the high speed direction of the data connection.

13. The method as recited in claim 1, wherein the data connection is a packet oriented data connection.

14. The method as recited in claim 1, wherein the data connection is a data connection according to the Transmission Control Protocol TCP.

15. An apparatus, comprising:
a control unit to control a transmission rate of acknowledgements, the acknowledgements being transmitted in a high speed direction of a data connection and the acknowledgements acknowledging receipt of data being transmitted in a low speed direction of the data connection.

16. The apparatus as recited in claim 15, the control unit further to control the transmission rate of acknowledgements depending on a degree of utilisation of a transmission bandwidth in the low speed direction of the data connection.

17. The apparatus as recited in claim 15, the control unit further to avoid a saturation of a transmission bandwidth in the low speed direction of the data connection.

18. The apparatus as recited in claim 15, the control unit further to limit the transmission rate of acknowledgements.

19. The apparatus as recited in claim 15, the control unit further to delay the acknowledgements.

20. The apparatus as recited in claim 15, further comprising:
a monitoring unit to monitor a filling level of a data buffer in the low speed direction of the data connection.

21. The apparatus as recited in claim 15, the control unit further to avoid a complete filling of a data buffer in the low speed direction of the data connection.

22. The apparatus as recited in claim 15, the control unit further to maximise a transmission rate of further acknowledgements, the further acknowledgements being transmitted in the low speed direction of the data connection and acknowledging receipt of further data being transmitted in the high speed direction of the data connection.

23. A wireless device comprising an apparatus as recited in claim 15.
